(19) United States
(12) Patent Application Publication
(10) Pub. No.: US 2015/0208705 A1
(43) Pub. Date: Jul. 30, 2015

(54) ANTHOCYANIN COLOURING COMPOSITION

(71) Applicant: NESTEC S.A., Vevey (CH)

(72) Inventors: Nicola Galaffu, Ornex (FR); Martin Michel, Lausanne (CH); Sandrine Cavin, Epalinges (CH); Karlheinz Bortlik, Syens (CH); Patrick Choisy, Montlouis sur Loire (FR)

(21) Appl. No.: 14/418,542

(22) PCT Filed: Aug. 6, 2013
(86) PCT No.: PCT/EP2013/066436

§ 371 Date: Jan. 30, 2015

Related U.S. Application Data
(60) Provisional application No. 61/724,334, filed on Nov. 9, 2012.

(30) Foreign Application Priority Data
Aug. 9, 2012 (EP) 12179903.5

(51) Int. Cl. A23L 1/275; A23G 3/34; A23G 9/32

(52) U.S. Cl. CPC A23L 1/2751; A23G 9/322; A23G 3/343; A23V 2002/00

(57) ABSTRACT

The present invention relates generally to the field of colouring compositions. One aspect of the invention is a colouring composition having a blue colour. In particular, the present invention relates to a colouring composition having a blue colour wherein the composition comprises anthocyanins, metal ions, and at least one stabilizer. The metal ions are selected from Al(III), Ca(II), Cu(II), Fe(II), Fe(III), Mg(II), Mn(II), Zn(II) and combinations thereof; while the stabilizers are selected from tannic acid and phospholipids. The invention provides for example a composition comprising the colouring composition and also provides for the use of the colouring composition to colour a food, a nutritional formulation, a food supplement, a beverage, an ink or a pharmaceutical product. A further aspect of the invention is a method of preparing a blue colouring composition.

The present invention relates generally to the field of colouring compositions. One aspect of the invention is a colouring composition having a blue colour. In particular, the present invention relates to a colouring composition having a blue colour wherein the composition comprises anthocyanins, metal ions, and at least one stabilizer. Suitable metal ions may be Al(III), Ca(II), Cu(II), Fe(II), Fe(III), Mg(II), Mn(II), Zn(II); while suitable stabilizers may be tannic acid and phospholipids. The invention provides for example a composition comprising the colouring composition and also provides for the use of the colouring composition to colour a food, a nutritional formulation, a food supplement, a beverage, an ink or a pharmaceutical product. A further aspect of the invention is a method of preparing a blue colouring composition.

Colour is an important part of our everyday lives, influencing our moods and emotions and enhancing the enjoyment of our surroundings. Natural colours are all around us, for example in trees, leaves, vegetables and flowers. People have made use of colours since prehistoric times, and today colours are found in a wide variety of products including textiles, paints, printed materials, cosmetics and plastics. Colour is a particularly important aspect of our enjoyment of food and can even affect our perception of flavour and aroma (Christensen, C. M., (1983), Journal of Food Science, 48,787-790 (1983)).

There is considerable interest in identifying natural colourants as these have a greater consumer acceptance than synthetic colourants, especially when used in food or in other products which are to be ingested. The range of colours achievable with natural colourants is currently not as extensive as can be achieved with synthetic colourants and in many cases the natural colourants have lower stability when exposed to light, temperature or different acidities. In particular there are very few blue colourants from natural sources, and those that do exist are generally unstable or not normally consumed as such. Perhaps because of their rarity in normal foodstuffs, children are particularly attracted to foods coloured blue. For example, in a confectionery product with sweets of multiple colours such as SMARTIES® chocolate dragees, many children consider the blue sweets to be their favourite.

Anthocyanins present a potential natural source of blue colourant. They are present in many plants, giving colour to fruits, vegetables and flowers. The colour of anthocyanins varies according to the pH. At low pH values anthocyanins are typically red in colour. As the pH is raised, anthocyanins become blue but have very limited stability. WO7901128 discloses gels of anthocyanins extracted from the Ipomoea tricolor species of morning glory. These gels can provide a blue colour at a pH of 8.0 but, due to the low stability of the colour, they need to be kept refrigerated.

Anthocyanins are known to interact with organic compounds or metal ions to produce a change in colour. The organic compounds or metal ions acting in this way are known as co-pigments. The anthocyanin-co-pigment interaction can increase the light absorption intensity (hyperchromic effect) and/or the absorption wavelength (bathochromic/ipsochromic shift). Many blue colours in plants are due to anthocyanin-metal ion complexes (A Castañeda-Ovando et al., Food Chemistry, 113, 859-871 (2009)). However, once isolated from the plant these colours are often unstable. US2010/0121084 describes reacting anthocyanins with aldehydes to achieve a bathochromic modification towards a more blue colour.

WO9714319 discloses the use of plant extracts such as flavonoid glycuronides, flavonoid glucuronides and caffeic acid derivatives to deepen the colour and improve the stability of anthocyanins. GB2119811 describes an anthocyanin grape extract colourant stabilized with tannic acid. In both WO9714319 and GB2119811 the colours obtained are the red hues typically expected from anthocyanins at acidic pH.

US2011/0129584 discloses a blue colourant comprising a buffer, an anthocyanin and a divalent ion source. The buffer raises the pH of the colourant to achieve a consistent blue shade from the anthocyanin, and the use of divalent ions such as calcium is said to inhibit colour degradation in the anthocyanins and so prolong shade retention. The pH range of the blue colourant in US2011/0129584 is between 5 and 10. U.S. Pat. No. 7,279,189 discloses a water soluble blue colourant comprising red cabbage liquid, aluminium sulphate and sodium bicarbonate. Red cabbage liquid contains anthocyanins, and the resulting colourant is able to retain its blue hue when combined with substances with pH values above 5.5.

WO2004/012526 describes adjusting the pH of anthocyanins, for example from red s cabbage, to between 7 and 9 to form a blue colour and then stabilizing this by incorporation with granulated sugar.

EP1279703 and EP1798262 disclose forming blue lakes with anthocyanins. Lake colours are made by precipitating a water soluble colour onto an insoluble substratum. The resulting slurry is then generally washed, dried and ground to a fine powder which can be dispersed in a carrier to provide a colouring material. In EP1279703 and EP1798262 the substratum is alumina. A degree of stability is achieved for the blue anthocyanin colour in this manner. However, lake colours are not always desired in product formulations as the particle suspensions require careful handling and the colouring properties of lakes are highly dependent on achieving an even distribution of the lake particles. Also, in certain product matrices, having solid particles of lake colours can nucleate undesirable crystallization of other components. Another potential issue with lake colours is that, in a product formulation with a low pH, the lakes can “bleed”. This is where the colour dissociates from the solid support and becomes soluble once more, potentially migrating through the product formulation. In the case of blue anthocyanin lake colours, the colour may not only “bleed” at low pH but may change colour and become red.

Unfortunately, the blue colouring compositions from natural sources currently available are not entirely satisfactory, in particular in terms of their stability. It would therefore be desirable to provide blue colouring compositions from natural sources which are sufficiently stable to retain their colour over time, especially in acidic conditions.

The object of the present invention is to improve the state of the art and in particular to provide a colouring composition having a blue colour, overcoming at least some of the disadvantages described above.

The inventors were surprised to see that the object of the present invention could be achieved by the subject matter of the independent claims. The dependent claims further develop the idea of the present invention.

Accordingly, the present invention provides a colouring composition having a blue colour wherein the composition comprises one or more anthocyanins; metal ions selected from the group consisting of Al(III), Ca(II), Cu(II), Fe(II), Fe(III), Mg(II), Mn(II), Zn(II) and combinations thereof; and at least one stabilizer selected from the group consisting of tannic acid and phospholipids. It has been surprisingly found by the inventors that anthocyanins in their blue form can be stabilized by the addition of these metal ions and at least one component selected from the group consisting of tannic acid and phospholipids. The inventors found that the colouring compositions of the present invention exhibit much smaller changes in colour when the pH is altered between pH 7 and pH 3 compared with the non-stabilized anthocyanins. The compositions remain blue as the acidity is increased to values where anthocyanins usually become violet or red. The inventors also found that the colouring compositions of the current invention are more stable with regard to light exposure over time. The colour change for a colouring composition comprising red cabbage extract according to the present invention being only 70% of that observed for non-stabilized red cabbage extract after 4 weeks' exposure to simulated daylight.

The invention also relates to the use of a stabilized colouring composition having a blue colour to colour products such as food, nutritional formulations, food supplements, beverages, inks or pharmaceutical products. The inventors were surprised to find that the colouring composition imparted attractive stable blue colours when used to colour products such as confectionery and ice cream.

In a further aspect, the invention relates to a method for preparing a blue colouring composition which comprises adjusting the pH of an anthocyanin solution to between 3.5 and 8.0 before adding metal ions selected from the group consisting of Al(III), Ca(II), Cu(II), Fe(II), Fe(III), Mg(II), Mn(II), Zn(II) and combinations thereof; and at least one component selected from the group consisting of tannic acid and phospholipids. The inventors found that this provided an efficient and practical method to prepare a stabilized blue anthocyanin colour. Without wishing to be bound by theory, the inventors currently believe that the initial adjustment of pH causes the anthocyanin to adopt its blue form whereupon it can form complexes with metal ions and be further stabilized by tannic acid and/or phospholipids. Once stabilized in this way, the colouring composition is resistant to further changes in pH or to fading induced by light.

Consequently the present invention relates in part to a colouring composition having a blue colour wherein the composition comprises one or more anthocyanins; metal ions selected from the group consisting of Al(III), Ca(II), Cu(II), Fe(II), Fe(III), Mg(II), Mn(II), Zn(II) and combinations thereof; and at least one stabilizer selected from the group consisting of tannic acid and phospholipids.

Blue is the hue of that portion of the visible spectrum lying between green and indigo. One method of measuring colour proposed by the Commission Internationale de I'Eclairage (CIE) is the CIE 1976 L*a*b* colour scale, herein abbreviated as CIELAB (CIE Technical Report, Colorimetry 2^{nd} Edition, CIE 15.2-1986, corrected reprint 1996). The CIELAB colour space is produced by plotting the quantities L*, a*, b* in rectangular coordinates. The L* coordinate of an object is the lightness intensity as measured on a scale from 0 (black) to 100 (absolute white). The a* and b* coordinates have no specific numerical limits. The parameter a* runs from pure green (negative a*) to pure red (positive a*), while b* runs from pure blue (negative b*) to pure yellow (positive b*).

The hue angle h_{ab} is calculated from a* and b* values as:

h_{ab}=arctan(b*/a*)

where h_{ab} lies between 0° and 90° if b* and a* are both positive, between 90° and 180° if b* is positive and a* is negative, between 180° and 270° if b* and a* are both negative, and between 270° and 360° if b* is negative and a* is positive.

“Blue” within the scope of the present invention refers to a CIELAB hue angle h_{ab} between 210° and 325°, for example between 225° and 315°.

Anthocyanins are glycosides of polyhydroxy and polymethoxy derivatives of 2-phenylbenzopyrylium or flavylium salts (Jin-Ming Kong et al., Phytochemistry, 64, 923-933 (2003)). Anthocyanidins are the basic structures of anthocyanins, with formula (I) where R₁ to R₇ are, independently, H, OH or OMe.

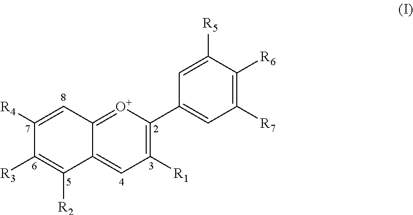

When anthocyanidins are found in their glycoside form (bonded to a sugar moiety) they are known as anthocyanins. There are reports of more than 500 different anthocyanins in nature. The main differences between them are the number of hydroxylated or methoxylated groups, the nature and number of sugars bonded to their structure, the aliphatic or aromatic carboxylates bonded to the sugar in the molecule and the position of these bonds (A Castañeda-Ovando et al., Food Chemistry, 113, 859-871 (2009)). The substitution pattern of the six most common anthocyanidins and their abbreviations are shown in table 1. The numbering of the substituents Rₙ is as drawn in the formula (I) above.

TABLE 1
Common anthocyanidins

| Name (Abbreviation) | R₁ | R₂ | R₃ | R₄ | R₅ | R₆ | R₇ |
|---|---|---|---|---|---|---|---|
| Cyanidin (Cy) | OH | OH | H | OH | OH | OH | H |
| Delphinidin (Dp) | OH | OH | H | OH | OH | OH | OH |
| Pelargonidin (Pg) | OH | OH | H | OH | H | OH | H |
| Peonidin (Pn) | OH | OH | H | OH | OMe | OH | H |
| Petunidin (Pt) | OH | OH | H | OH | OMe | OH | OH |
| Malvidin (Mv) | OH | OH | H | OH | OMe | OH | OMe |

In order of relative abundance, the sugars found bound to anthocyanidins to form anthocyanins are glucose, rhamnose, galactose, xylose, arabinose and glucuronic acid. The main glycoside derivatives in nature are 3-monosides, 3-biosides, 3,5-diglucosides and 3,7-diglucosides. Anthocyanins may also be acylated. One or more molecules of the acyl acids; p-coumaric, ferulic and caffeic; or the aliphatic acids;

malonic and acetic; may be esterified to the sugar molecule (F. J. Francis, Colorants, p56, Eagan Press (1999)). Overall, the most widespread anthocyanin is cyanidin-3-O-glucoside.

The anthocyanins of the present invention may have the formula (I) wherein R₁, R₂ and R₄ are each independently H, OH, OMe, a sugar residue, or an acylated sugar residue; and R₃, R₅, R₆ and R₇ are each independently H, OH or OMe. The anthocyanins may be synthetic and/or natural anthocyanins.

The metal ions of the present invention are selected from the group consisting of Al(III), Ca(II), Cu(II), Fe(II), Fe(III), Mg(II), Mn(II), Zn(II) and combinations thereof. The metal ions may be selected from the group consisting of Al(III), Fe(II) and Fe(III), for example the metal ions can be Fe(III). These ions are particularly effective at stabilizing the anthocyanins via the formation of complexes as well as causing a bathochromic shift toward blue hues. Salts providing these ions are well known, with anions such as gluconate, chloride, sulphate, oxide, hydroxide and acetate. For example, calcium gluconate contains Ca(II) ions (Ca²⁺); Magnesium chloride, MgCl₂, contains Mg(II) ions (Mg²⁺); ferrous sulphate, FeSO₄, contains Fe(II) ions (Fe²⁺); ferric sulphate, Fe₂(SO₄)₃, contains Fe(III) ions (Fe³⁺); and aluminium sulphate, Al₂(SO₄)₃, contains Al(III) ions (Al³⁺). For food applications it is important to select ions and sources of these ions which are non-toxic.

Tannic acid or hydrolyzable gallotannin is a mixture of polygalloyl glucoses or polygalloyl quinic acid esters with the number of galloyl moieties per molecule ranging from 2 up to 12 depending on the plant source used to extract the tannic acid. The chemical formula for commercial tannic acid is often given as C₇₆H₅₂O₄₆, which corresponds to decagalloyl glucose and provides an approximate average molar mass. The tannic acid of the colouring composition of the present invention may for example be decagalloyl glucose, although decagalloyl glucose is only one of the possible components of tannic acid. Commercial tannic acid is usually extracted from seed pods of Tara (Caesalpinia spinosa); the nutgalls or the excrescences that form on the young twigs of Quercus infectoria Olivier and allied species of Quercus L. (Fam. Fagaceae); or the nutgalls of various sumac species. Although tannic acid is a specific type of tannin the two terms are not interchangeable.

Phospholipids are a class of lipids that are a major component of all cell membranes as they can form lipid bilayers. A phospholipid molecule is constructed from four components: fatty acids, a “backbone” to which the fatty acids are attached and a phosphate ester. The “backbone” of the phospholipids may be glycerol or sphingosine. Phospholipids derived from glycerol are called phosphoglycerides (Biochemistry 5^{th} Edition, J. Berg et al., W.H. Freeman & Co (2002)). Examples of phospholipids include phosphatidic acid, phosphatidyl ethanolamine, phosphatidyl choline, phosphatidyl serine, phosphatidyl inositol, phosphatidyl inositol phosphate, phosphatidyl inositol bisphosphate, phosphatidyl inositol triphosphate, ceramide phosphoryl choline, ceramide phosphoryl ethanolamine and ceramide phosphoryl glycerol.

Phospholipids are one of the components of lecithin. Lecithin is found in egg-yolks as well as being extracted from seed oils. The phospholipids of the present invention may be provided in the form of soy or sunflower lecithin. The main phospholipids in soy and sunflower lecithin are phosphatidyl choline, phosphatidyl inositol, phosphatidyl ethanolamine and phosphatidic acid. For example, the phospholipids of the colouring composition of the present invention may be phosphatidyl choline.

A well-known measure of the acidity of an aqueous solution is pH. As measurements of pH are temperature dependent, values given in the present specification refer to the pH at 25° C. For compositions such as powders which are not solutions, pH was measured after mixing 1 part of the composition in 9 parts deionized water. Most food materials and beverages have a pH below 7. A colouring composition of the present invention may have a pH below 7. This is advantageous as it allows the colouring composition to impart a blue colour to materials having a pH below 7 without the requirement to isolate the colouring composition from the material in some way. Preferably the pH of the colouring composition is between 3 and 7, for example between 4 and 6 or, by way of further example, between 4 and 5.5.

In the present invention, the one or more anthocyanins may be from natural sources. Many people are concerned about the safety of materials industrially synthesised from chemical feedstock, especially when these materials are to be ingested and prefer materials obtained from natural sources. A number of plants are naturally rich in anthocyanins. These include purple carrot, elderberry, hibiscus, blackcurrant, purple corn and purple potato. The four major anthocyanins present in blackcurrant fruit are cyanidin-3-O-rutinoside, cyanidin-3-O-rutinoside, delphinidin-3-O-glucoside and delphinidin-3-O-rutinoside. Grapes and red cabbage are two important sources of anthocyanins in nature. The anthocyanidin units of the anthocyanins found in grapes are cyanidin, peonidin, malvidin, petunidin and delphinidin; and the organic acids are acetic, coumaric and caffeic. The only sugar present is glucose. (F. J. Francis, Colorants, p56, Eagan Press (1999)). An anthocyanin from grapes, malvidin-3,5,-diglucoside is shown in formula (II), where Glu is glucose and Me is methyl.

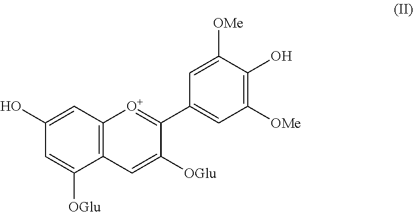

The anthocyanins of the present invention may be cyanidin-3-O-rutinoside, delphinidin-3-O-rutinoside, cyanidin-3-O-glucoside or malvidin-3,5,-O-diglucoside.

Seven of the anthocyanins found in red cabbage are shown in formula (III). The anthocyanins share the basic cyanidin-3-diglucoside structure but with differing R₁ and R₂ groups. The R₁ and R₂ groups for these seven anthocyanins are sinapyl, ferulyl or p-coumarl as shown in table 1.

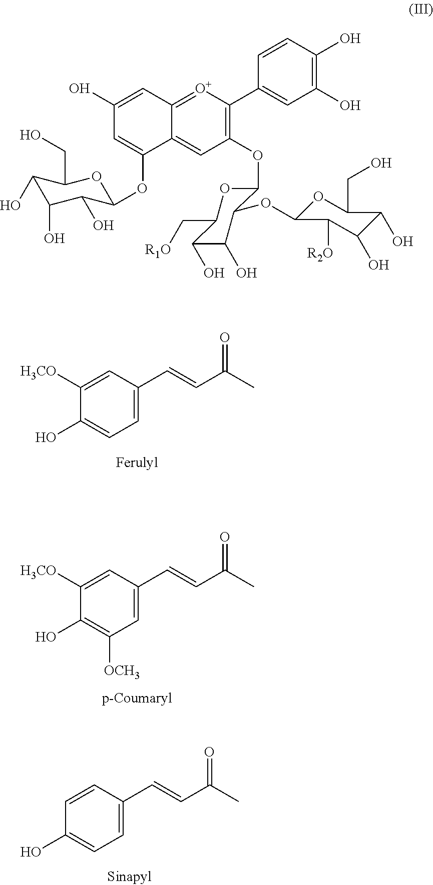

TABLE 1

| | R₁ | R₂ |
|---|---|---|
| A | H | Sinapyl |
| B | Sinapyl | H |
| C | Ferulyl | H |
| D | p-Coumaryl | H |
| E | Sinapyl | Sinapyl |
| F | Ferulyl | Sinapyl |
| G | p-Coumaryl | Sinapyl |

The anthocyanins of the present invention may be one or more of the cyanidin-3-diglucosides with the structure (III) and the substituents R₁ and R₂ as listed in table 1 as compounds A to G.

The one or more anthocyanins of the present invention may be added in the form of plant material; or an extract of plant material. This can be advantageous to avoid unnecessary purification of the anthocyanins. Also, the other components of the plant material may be beneficial in the colouring composition or the final product. For example, other components of plant material such as flavonoids provide nutritional benefits when included in food. Consumers of food products like to see that plant material such as fruit and vegetables are included as ingredients.

Plant material may be for example vegetables, fruits or flowers. The plant material may be selected from the group consisting of red cabbage, red onion, purple sweet potato, grape, cranberry, strawberry, raspberry, chokeberry, black soybean, blackcurrant, elderberry, hibiscus, radish, blueberry, bilberry, cherry, aubergine, black carrot, purple carrot and black rice. Although many plants contain anthocyanins, the ones in this group are grown as commercial crops and so are more readily available than other sources.

The composition of the present invention may comprise one or more acidity regulators. Acidity regulators are substances which alter or control the acidity or alkalinity of a material. For example, an extract from red cabbage comprising anthocyanins is naturally acidic and so an acidity regulator such as sodium acetate may be added to raise the pH to a point where the anthocyanins become blue and can then be stabilized in their blue form by the other components of the colouring composition of the present invention. Other examples of acidity regulators include potassium phosphate, potassium tartrate, potassium bicarbonate and sodium bicarbonate. Acidity regulators may also be combinations of a weak acid and the corresponding salt which together act as a buffer, providing a composition which is resistant to changes in pH, for example the combination of sodium acetate and acetic acid. In the scope of the present invention the acidity regulators are not limited to those which are approved by various legislators for use in food, for example by the European Community (Regulation (EC) 1333/2008 of the European Parliament and of the Council of 16 Dec. 2008 on food additives). However, clearly those acidity regulators which are locally approved for use will be preferred in food applications.

In the CIELAB colour space, colour difference may be calculated as a single value taking into account the differences between the L*, a* and b* values of two samples. The colour difference ΔEab* is calculated as follows:

ΔEab*=\sqrt{(ΔL*)²+(Δa*)²+(Δb*)²}

As anthocyanins are sensitive to changes in pH it is valuable to be able to provide colouring compositions comprising anthocyanins which retain their colour despite changes in pH. Surprisingly, the colouring compositions of the present invention are stable with regard to pH. For example, the colour difference ΔEab* between pH 7 and pH 5 is less than 10, preferably less than 5, and the colour difference ΔEab* between pH 7 and pH 3 is less than 20, preferably less than 10.

The relative proportions of anthocyanins, metal ions and stabilizer are not limited. However, for best results a large proportion of the anthocyanin molecules should be complexed with a metal ion and be in close contact with a stabilizer molecule. The composition of the present invention may have a molar ratio of the metal ions to the anthocyanins of at least 0.5:1. The molar ratio of the metal ions to the anthocyanins may be considerably higher than 0.5:1, especially when metal ions in the group consisting of Al(III), Ca(II), Cu(II), Fe(II), Fe(III), Mg(II), Mn(II), Zn(II) are included in another component of the colouring composition such as an acidity regulator. The molar ratio of metal ions to anthocyanins may be between 0.5:1 and 100:1, for example between 1:1 and 50:1. The composition of the present invention may have a molar ratio of the stabilizer to the anthocyanins of at least 0.5:1, for example between 0.5:1 and 15:1, for further example between 1:1 and 8:1.

Formulating a composition on the basis of molar ratios requires knowledge of the components' molar mass or molar concentration. Where the component does not consist of a single pure compound, an average molar mass or molar concentration should be taken. This can be for example the values for a representative pure compound. In the present invention, in the absence of more specific values, the representative pure compound for anthocyanin is taken to be cyanidin-3-O-glucoside. On this basis, the molar concentration of anthocyanin in the source material can be measured spectrophotometrically (J. Lee et al., Journal of AOAC international, 88, 5, 1269-1278 (2005)). In the case of tannic acid, the representative pure compound is taken as decagalloyl glucose with a molar mass of 1701 g/mol and so the number of moles can be determined by weight. For phospholipids the representative compound is phosphatidylcholine with a molar mass of 776 g/mol.

It is often convenient when handling colouring compositions for them to be provided in the form of a powder. When colouring compositions are to be made up in a solvent it is inefficient to transport and store the colouring composition together with its solvent, especially when the solvent is readily available such as water. It may therefore be preferable to have a powdered form of the colouring composition. This can be achieved for example by spray drying the colouring composition together with a suitable carrier, for example modified starches such as maltodextrins. The colouring composition of the present invention may be a spray-dried powder further comprising a spray drying carrier.

The colouring composition of the present invention may be used to colour a wide variety of materials. For example it may be used to colour a food, a nutritional formulation, a food supplement (sometimes referred to as an oral supplement), a beverage, an ink or a pharmaceutical product.

Foods which may be coloured by the colouring composition of the present invention are diverse in character, for example: ice-creams; sweet desserts such as table jellies and blancmange; confectionery such as gums and jellies, pressed sugar tablets, chewing gum, dragees, high boiled sweets; white chocolate and other fat based confectionery products; fillings for biscuits or cakes; jam; cakes; cake icing; whipped cream; yogurt; milk-based fermented products; cereal-based products or fermented cereal-based products; inclusions for breakfast cereal; milk-based powders; soups, sauces, pasta including pasta shapes, bread, tortillas, tortilla chips, extruded snacks, biscuits and animal feed. In particular, the invention provides for the use of the colouring composition of the invention to colour a confectionery product, a bakery product, an ice-cream or a pet food.

The beverages which may be coloured through the use of the present invention may be chilled or shelf stable beverages; carbonated drinks; beverages containing coloured fruit pieces or pulp; fruit juices; vegetable juices; squashes and cordials; milk and milk shakes. Milk has traditionally been difficult to colour using anthocyanins. The low acidity of a typical anthocyanin extract causes phase separation due to protein precipitation. The colouring composition of the present invention can be used to colour milk without causing phase separation.

Inks are liquids or pastes used to colour a surface to produce an image, text, or design. Ink is generally applied with a pen, a brush or by a printing method. There are only a limited number of edible inks, and very few have colours from natural sources. The colouring composition of the present invention may be used in an edible ink, for example to decorate food, to mark pharmaceutical tablets or for use on packaging which will be in direct contact with food. Food with printed text, logos, images or designs can be very appealing to consumers and may provide aesthetic enhancement, product recognition, personalization and a sense of fun.

The colouring composition of the present invention may be used in combination with another colouring composition. For example, in combination with yellow colouring compositions green shades can be achieved, and in combination with orange colouring compositions a brown colour can be obtained.

Another aspect of the invention relates to a method of preparing a blue colouring composition comprising adjusting the pH of an anthocyanin solution to between 3.5 and 8.0 before adding metal ions selected from the group consisting of Al(III), Ca(II), Cu(II), Fe(II), Fe(III), Mg(II), Mn(II), Zn(II) and combinations thereof; and at least one component selected from the group consisting of tannic acid and phospholipids. Adjusting the pH of the anthocyanin solution in this manner is optimum for providing a blue hue which can be effectively stabilized by the other components.

The colouring composition of the present invention may be comprised within other compositions. For example, in wheat flour tortillas, fumaric acid is often added to the dough to accelerate the cleavage of disulphide bonds between gluten protein molecules during dough kneading. This results in a more easily machined dough and faster production rates. The pH of the dough is around 5.5 to 6. The colouring composition of the present invention is suitable for addition to tortilla dough to create an attractive blue colour in the final tortilla. Another example of where the colouring composition may be added to an acidified composition is high boiled sweets. If a fruit flavor is desired in the high boiled sweet, for example blueberry, then the flavour impact is much enhanced by adding acids to the syrup composition used to make the high boiled sweet. For example a mixture of malic acid and sodium citrate may be used to impart the required sour taste without taking the pH below 3.5. The stability of the colouring composition of the present invention with regards to changes of acidity allows it to impart a blue colour when comprised within other compositions with a range of different pH. With the addition of a yellow colour to the composition, for example safflower yellow, a green colour can be produced. Accordingly, a further embodiment of the invention is a composition comprising the colouring composition of the present invention wherein the composition has a pH in the range of 3.5 to 8.0 and the composition has a blue or green colour.

Those skilled in the art will understand that they can freely combine all features of the present invention disclosed herein. In particular, features described for the product of the present invention may be combined with the method of the present invention and vice versa. Further, features described for different embodiments of the present invention may be combined. Further advantages and features of the present invention are apparent from the figures and non-limiting examples.

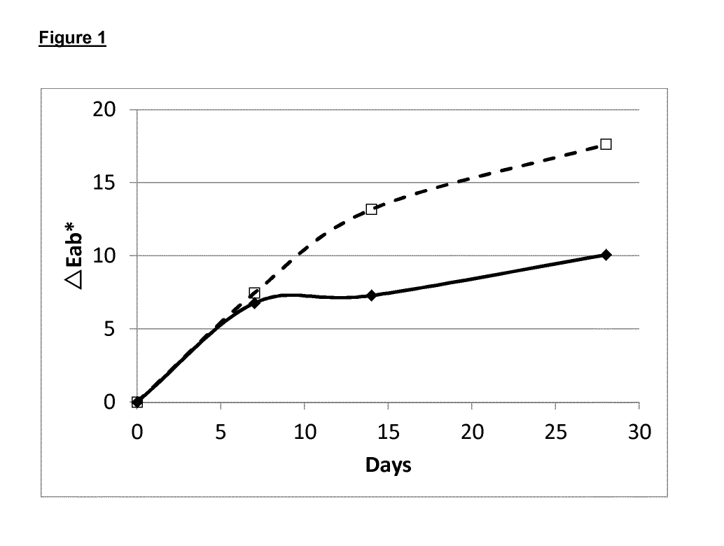

FIG. 1 shows the colour change ΔEab* of the colouring composition of example 1 (indicated by diamonds ♦) and a non-stabilized red cabbage extract (indicated by squares □) exposed to simulated daylight for 4 weeks.

### EXAMPLE 1

### Preparation of a Spray-Dried Blue Colouring Composition with Red Cabbage Extract, Fe(II) and Tannic Acid

1.5 kg of red cabbage extract (Diana Naturals—Red Cabbage Anthocyanins ELCHRO7017) was diluted into 8 litres of water and cooled to 4° C. 820 g sodium acetate was slowly added and the pH measured. The pH of the mixture was adjusted to be just above 5.5 by the careful addition of further quantities of sodium acetate. Stirring was applied and 195 g ferrous sulphate heptahydrate was added. The pH was checked and adjusted to be between 5.5 and 6.0 with sodium acetate as required. The mixture was stirred for 2 hours with the temperature maintained at 4° C. 170 g tannic acid (Ajinomoto Ominichem) was dissolved in 1 litre of 1M sodium acetate solution and slowly added to the mixture. After the addition, the pH was checked once more and adjusted to between 5.5 and 6.0. The total volume was made up to 10 litres and stirred for 16 hours at 4° C. 1 kg of 20 DE maltodextrin was then dissolved into the mixture and pasteurized at 75° C. for 1 hour. The mixture was s cooled and stirred for 48 h at 4° C. before being spray dried to obtain a powder.

The molar ratios can be calculated as follows:

Anthocyanins:

Red cabbage extract contains 0.06 mol/kg of anthocyanins (on cyanidin-3-O-glucoside basis). Therefore 1.5 kg red cabbage extract contains 0.09 mol anthocyanins.

Metal Ions:

Red cabbage extract contains 0.04 mmoles/kg of Fe, 8.05 mmol/kg of Ca, 4.52 mmol/kg of Mg, 0.01 mmol/kg of Mn and 0.01 mmol/kg of Zn. Therefore 1.5 kg red cabbage extract contains a total of 0.02 mol/kg of these metal ions.

FeSO₄.7H₂O has molar mass of 278 g/mol. Therefore 195 g FeSO₄.7H₂O contains 0.70 mol Fe.

Stabilizer (tannic acid):

Tannic acid has molar mass of 1701 g/mol (on decagalloyl glucose basis). Therefore 170 g contains 0.10 mol tannic acid

Ratio of metal ions:anthocyanin is 0.72:0.09 equivalent to 8:1

Ratio of stabilizer:anthocyanin is 0.10:0.09, equivalent to 1.11:1

The colour was measured as follows:

100 mg of the spray-dried colouring composition was dissolved in 100 mL MilliQ water. 3 mL aliquots were then diluted to 30 mL using the following buffers:
0.1 M Acetic acid buffer at pH 3
0.1 M Acetate buffer at pH 5
0.2 M Phosphate buffer at pH 7

Relative concentrations for the samples were adjusted in order to obtain a final absorbance of 0.8 units at each sample's λₘₐₓ in order to remain in the linear zone of the Beer-Lambert law during measurements. The CIELAB values were measured using an X-Rite Color-Eye 7000A. ΔEab* was calculated between pH 7 and pH 5 and between pH 7 and pH 3.

Red cabbage/Fe(II)/Tannic acid - Spray dried

| | L* | a* | b* | h_{ab} | ΔEab* |
|---|---|---|---|---|---|
| pH 7 | 15.6 | −1.75 | −9.3 | 259 | — |
| pH 5 | 14.6 | −1.3 | −10.25 | 263 | 1.5 |
| pH 3 | 18.35 | 3.7 | −11.5 | 288 | 6.5 |

The colour remained blue down to pH3 with only a small change compared to the colour at pH7.

For comparison, non-stabilized red cabbage extract gave
the following CIELAB values. Red cabbage (non-stabilized)

| | L* | a* | b* | h_{ab} | ΔEab* |
|---|---|---|---|---|---|
| pH 7 | 21.4 | 4.9 | −17.0 | 286 | — |
| pH 5 | 29.55 | 18.2 | −9.5 | 332 | 17.3 |
| pH 3 | 25 | 38.1 | −1.35 | 358 | 36.8 |

The colour changed to violet at pH5 and became even more red in colour at pH3. This demonstrates that a colouring composition comprising anthocyanin, metal ions and tannic acid retains its blue colour at pH values below 7, whereas a non-stabilized anthocyanin does not.

### EXAMPLE 2

### Preparation of a Spray-Dried Blue Colouring Composition with Red Cabbage Extract, Al(III) and Tannic Acid

The method and quantities of example 1 were repeated except that the ferrous sulphate was replaced by 171 g aluminium sulphate. For this example, the amount of tannic acid was increased to 510 g, dissolved in 2 litres of 1M sodium acetate solution.

Molar ratio of metal ions to anthocyanins is 11.3:1

Molar ratio of stabilizer to anthocyanin is 3.33:1

The colour was measured in the same way as for Example 1.

Red cabbage/Al(III)/Tannic acid - Spray dried

| | L* | a* | b* | h_{ab} | ΔEab* |
|---|---|---|---|---|---|
| pH 7 | 23.3 | −5.05 | −7.1 | 235 | — |
| pH 5 | 24.1 | 1.05 | −8.7 | 277 | 6.3 |
| pH 3 | 31.7 | 18.4 | −8.8 | 334 | 24.9 |

The colour remained blue at pH5, but when the pH was reduced to pH3 the colour became slightly violet. This demonstrates that blue anthocyanins can be stabilized against the effect of reducing pH by Al(III) ions in combination with tannic acid.

### EXAMPLE 3

### Method for Preparation of a Blue Colouring Composition with Red Cabbage Extract, Fe(III) and Tannic Acid

15 g red cabbage extract (0.9 mmol anthocyanin) (Diana Naturals—Red Cabbage Anthocyanins ELCHRO7017) was diluted in 100 mL of 0.1 M acetate buffer at pH 5.5. 1.13 g of iron (III) sulphate hydrate—22% Fe(III) (4.45 mmol Fe(III)) was added and the solution was stirred for 2 hours. 1.7 g Tannic acid (1.0 mmol) was then added to the mixture. The solution was stirred for 18 h and then pasteurized for 1 hour at 80° C. The mixture was cooled and stirred for 72 hours at 4° C. before being freeze dried. The blue powder obtained was stored at 4° C.

The colour was measured as follows:

100 mg of the freeze dried colouring composition was dissolved in 100 mL MilliQ water. 3 mL aliquots were then diluted to 30 mL using the following buffers:
0.1 M Acetic acid buffer at pH 3
0.1 M Acetate buffer at pH 5
0.2 M Phosphate buffer at pH 7

Relative concentrations for the samples were adjusted in order to obtain a final absorbance of 0.8 units at each sample's λₘₐₓ in order to remain in the linear zone of the Beer-Lambert law during measurements. The CIELAB values were measured using an X-Rite Color-Eye 7000A. ΔEab* was calculated between pH 7 and pH 5 and between pH 7 and pH 3.

Red cabbage/Fe(III)/Tannic acid - freeze dried

| | L* | a* | b* | h_{ab} | ΔEab* |
|---|---|---|---|---|---|
| pH 7 | 16.45 | −0.35 | −6.95 | 267 | — |
| pH 5 | 15.1 | 0.2 | −9.85 | 271 | 3.2 |
| pH 3 | 20.75 | 4.8 | −10.1 | 295 | 7.4 |

The colour remained blue down to pH3 with only a small change compared to the colour at pH7. This demonstrates that blue anthocyanins can be stabilized against the effect of reducing pH by Fe(III) ions in combination with tannic acid.

### EXAMPLE 4

### Preparation of a Blue Colouring Composition with Red Cabbage Extract, Fe(II) and Fe(III) and Phospholipids

15 g red cabbage extract (0.9 mmol anthocyanin) (Diana Naturals—Red Cabbage Anthocyanins ELCHRO7017) was diluted in 100 mL of 0.1 M acetate buffer at pH 5.5. The metal salts were added according to the amount reported in the table below and the solution was stirred for 2 hours. 2.7 g soya lecithin (ULTRALEC® F from ADM) (2.7 g at 62% phospholipid, 2.2 mmol) was added to the mixture. The solution was stirred for 18 hours and then pasteurized for 1 hour at 80° C. The mixture was cooled and stirred for 72 hours at 4° C. before being freeze dried. The blue powder obtained was stored at 4° C.

| Metal salt | Mass | Metal ions |
|---|---|---|
| FeSO₄ x 7H2O | 1.75 g | 6.3 mmol Fe(II) |
| Fe₂(SO₄)₃ hydrate 22% Fe(III) | 1.87 g | 7.4 mmol Fe(III) |

The colours were measured in the same way as for Example 3.

Red cabbage/Fe(II)/Phospholipids - freeze dried

| | L* | a* | b* | h_{ab} | ΔEab* |
|---|---|---|---|---|---|
| pH 7 | 27.2 | −8.9 | −6.1 | 214 | — |
| pH 5 | 20.2 | −5.85 | −11.4 | 243 | 9.3 |
| pH 3 | 30.9 | 15.3 | −5.9 | 339 | 24.5 |

The colour remained blue at pH5, but when the pH was reduced to pH3 the colour became slightly violet.

Red cabbage/Fe(III)/Phospholipids - freeze dried

| | L* | a* | b* | h_{ab} | ΔEab* |
|---|---|---|---|---|---|
| pH 7 | 26.85 | −4.15 | −0.3 | 184 | |
| pH 5 | 24.35 | −3.1 | −1.7 | 208 | 3.05 |
| pH 3 | 22.6 | 1.45 | −1.65 | 311 | 7.2 |

The colour remained blue down to pH3 with only a small change compared to the colour at pH7. This demonstrates that blue anthocyanins can be stabilized against the effect of reducing pH by the combination of Fe(II) or Fe(III) ions with phospholipids.

### EXAMPLE 5

### Stabilized Blue Colouring Composition with Anthocyanins from Different Plant Materials

A range of commercially available fruit or vegetable extracts were used as anthocyanin sources:

| | Anthocyanin loading | Amount used |
|---|---|---|
| Extracts | mmol/g* | (g) |
| Elderberry | 0.05 | 40 |
| Black Carrot | 0.09 | 22 |
| Red fruits mix | 0.10 | 20 |
| Black Rice | 0.77 | 2.6 |
| Raspberry powder | 0.023 | 87 |
| Grape skin | 0.30 | 6.6 |

*Calculated using Lee, Journal of AOAC international, 88, 5, 1269-1278 (2005)

The vegetable/fruit extract (2 mmol) was diluted in 150 mL of a pH 5.5 buffer. 3.9 g of ferrous sulphate heptahydrate (14 mmol) was slowly added to the mixture under stirring. After 2 h, 3.4 g of tannic acid solution (2 mmol dissolved in 50 mL of pH 5.5. buffer) was added to the mixture. The solution was stirred for 18 hours at 4° C. and then pasteurized for 1 h at 80° C. The mixture was cooled and stirred for 72 hours at 4° C. before being freeze dried. The blue powder obtained was stored at 4° C.

100 mg of each powder was dissolved in 100 mL MilliQ water. 3 mL aliquots were then diluted to 30 mL using the following buffers:
0.1 M Acetic acid buffer at pH 3
0.1 M Acetate buffer at pH 5
0.2 M Phosphate buffer at pH 7

The CIELAB values were measured using an X-Rite Color-Eye 7000A and compared to the non-stabilized red cabbage solution.

| | pH 3 | | | | pH 5 | | | | pH 7 | | | |
|---|---|---|---|---|---|---|---|---|---|---|---|---|
| | L* | a* | b* | h_{ab} | L* | a* | b* | h_{ab} | L* | a* | b* | h_{ab} |
| Non-Stabilized | 25.0 | 38.1 | −1.4 | 358 | 29.55 | 18.2 | −9.5 | 332 | 21.4 | 4.9 | −17.0 | 286 |
| Red Cabbage | | | | | | | | | | | | |
| Elderberry | 14.2 | 2.9 | −4.1 | 306 | 10.35 | 1.9 | −3.1 | 301 | 9.7 | 2.3 | −1.7 | 324 |
| Black Carrot | 21.1 | 2.8 | −5.4 | 297 | 18.5 | 1.1 | −5.2 | 282 | 18.8 | 1.2 | −3.6 | 288 |
| Red fruits mix | 23.8 | 2.8 | −5.9 | 295 | 20.6 | 1.3 | −5.7 | 283 | 20.9 | 1.3 | −4.0 | 288 |
| Black Rice | 28.4 | 0.9 | −2.5 | 290 | 26.6 | 0.8 | −2.5 | 288 | 27.3 | 1.5 | −1.3 | 319 |
| Raspberry | 4.6 | 1.4 | −3.6 | 291 | 4.3 | 1.6 | −2.8 | 300 | 4.2 | 1.7 | −2.3 | 306 |
| Grape Skin | 2.5 | 1.1 | −2.3 | 296 | 2.4 | 1.0 | −2.0 | 297 | 2.7 | 0.9 | −1.7 | 298 |

ΔEab* was calculated between pH 7 and pH 5 and between pH 7 and pH 3.

| Anthocyanin source | ΔEab* pH 7-5 | ΔEab* pH 7-3 |
|---|---|---|
| Non-Stabilized | 17.3 | 36.8 |
| Red Cabbage | | |
| Elderberry | 1.65 | 5.1 |
| Black Carrot | 1.6 | 3.3 |
| Red fruits mix | 1.75 | 3.7 |
| Black Rice | 1.5 | 1.7 |
| Raspberry | 0.55 | 1.4 |
| Grape Skin | 0.4 | 0.6 |

This demonstrates that anthocyanins according to the invention can be added in the form of vegetable extracts. Colouring compositions according to the invention retain their blue colour at pH values below 7, whereas a non-stabilized anthocyanin becomes violet or red.

### EXAMPLE 6

### Stabilization Against Light Exposure

100 mg of the spray-dried colouring composition of Example 1 was dissolved in 100 mL MilliQ water. 3 mL aliquots were then diluted to 30 mL using 0.2 M Phosphate buffer at pH 7. The solutions were continuously irradiated under simulated daylight (D65, 1500 Lux) for 4 weeks and compared to the non-stabilized red cabbage extract. The colour measurements were carried out before irradiation, after 1 week, 2 weeks and 4 weeks irradiation. Colour changes were reported as ΔEab* (FIG. 1) and were calculated using the formula:

ΔEab*=\sqrt{(L*ₜ−L*ₜ_{⁰})²+(a*ₜ−a*ₜ_{⁰})²+(b*ₜ−b*ₜ_{⁰})²}

where L*ₜ, a*ₜ and b*ₜ are the values measured at a certain irradiation time and L*ₜ_{⁰}, a*ₜ_{⁰} and b*ₜ_{⁰} are the values measured before the irradiation.

The colouring composition of example 1 remained blue during the exposure to simulated daylight. After 4 weeks, the colour change measured by ΔEab* was approximately 70% of that observed with a non-stabilized blue colour. This demonstrates that the colouring compositions of the present invention have good stability to sunlight.

### EXAMPLE 7

### Colouring Ice Cream

A simple ice cream mix with 10% fat, 11.5% non-fat milk solids, 15.0% sugar, 0.3% stabilizer-emulsifier and 63.2% water was mixed in a 50 L double jacked container at 65° C. The mixture was heated to 86° C., and after 30 minutes the mixture was cooled to 4° C. and allowed to mature for 20 hours. The spray-dried blue powder of example 1 was mixed into 1 Kg of the uncoloured ice cream mix at a level of 0.2%. The resulting coloured ice cream base was then made into ice cream using a Carpigiani Labo 812E Batch Freezer. Another 1 Kg of ice cream mix was coloured with the spray-dried blue powder of example 2, also at a level of 0.2%.

Both samples of ice cream had an attractive shade of blue and an overrun of about 75%. The ice creams were stored for 3 months at −15° C. The colour did not show any sign of fading, and the ice creams did not have an undesirable taste. The colouring composition of the current invention can therefore be used to colour foods, in this example, ice cream.

### EXAMPLE 8

### Colouring Sugar-Coated Dragees

A spray-dried blue colouring composition with red cabbage extract, Fe(II) and tannic acid was prepared as follows. 1.5 kg of red cabbage extract (Diana Naturals—Red Cabbage Anthocyanins ELCHRO7000) was diluted into 8 litres of water and cooled to 4° C. 270 g disodium hydrogen phosphate was slowly added and the pH measured. The pH of the mixture was adjusted to be just above 5.5 by the careful addition of sodium bicarbonate. Stirring was applied and 195 g ferrous sulphate heptahydrate was added. The pH was checked and adjusted to be between 5.5 and 6.0 by the further addition of sodium bicarbonate. The mixture was stirred for 2 hours with the temperature maintained at 4° C. 170 g tannic acid (Ajinomoto Ominichem) was dissolved in 1 litre of water and slowly added to the mixture. After the addition, the pH was checked once more and adjusted to between 5.5 and 6.0. The total of all the additions of sodium bicarbonate was 100 g. The total volume was made up to 10 litres and stirred for 16 hours at 4° C. 1 kg of 20 DE maltodextrin was then dissolved into the mixture and pasteurized at 75° C. for 1 hour. The mixture was cooled and stirred for 48 h at 4° C. before being spray dried to obtain a spray-dried blue colouring composition.

A colour syrup was made up of:

| | |
|---|---|
| Sucrose syrup, 76% total solids | 142 g |
| Spray-dried blue colouring composition | 10.5 g |
| Water | 13 g |

15 kg of white hard sugar-coated lentil shaped sweets with a chocolate centre (part-processed SMARTIES®) were placed in a revolving pan. The colouring syrup was applied warm, in 10 applications, to the sweets tumbling in the pan. After each application of syrup, the sweets were allowed to tumble with no drying air until they had just lost the shine on their surface. A current of room temperature air was then applied. Once dry, the next application of syrup was made. On the last application of syrup, once the sweets had lost their shine, the pan was revolved intermittently for twenty minutes with no air applied. The sweets were then transferred to a beeswax-lined drum and polished with powdered carnuba wax (0.7 g) for 20 minutes.

The resulting SMARTIES® sweets had an attractive blue colour which did not fade perceptibly during several months' storage in daylight. The flavour of the coloured sweets was not noticeably different from the uncoloured sweets. The colouring composition of the current invention can therefore be used to colour foods, in this example, chocolate-centred sugar-coated confectionery dragees.

### EXAMPLE 9

### Comparison of Stability of Colouring Compositions with Fe(II) and Tannic Acid Used Separately

Non-Stabilized Red Cabbage Solution

In a 1 L Duran flask, equipped with a magnetic stirrer, the red cabbage extract (32.2 g) was diluted with demineralised water (700 mL). Disodium hydrogen phosphate (5.7 g) and sodium bicarbonate (2.15 g) were slowly added to have a 5.5<pH<6.0. The solution was pasteurized at 75° C. for 2 h and cooled down to room temperature. The colours of the solution at different pH values were measured as for Example 1. ΔEab* was calculated between pH 7 and pH 5 and between pH 7 and pH 3.

Red cabbage

| | L* | a* | b* | h_{ab} | ΔEab* |
|---|---|---|---|---|---|
| pH 7 | 40.4 | 5.9 | 0.0 | 360 | — |
| pH 5 | 43.8 | 12.7 | 3.2 | 14 | 8.2 |
| pH 3 | 41.3 | 25.0 | 6.0 | 13.5 | 20.1 |

This red cabbage colour was not blue at any of the pH values, it was a reddish brown colour.

Red Cabbage+Tannic Acid In a 1 L Duran flask, equipped with a magnetic stirrer the red cabbage extract (32.2 g) was diluted with demineralised water (700 mL). Disodium hydrogen phosphate (5.7 g) and sodium bicarbonate (2.15 g) were slowly added to have a 5.5<pH<6.0. Tannic acid (3.4 g) was added slowly. The solution was pasteurized at 75° C. for 2 h and cooled down to room temperature. The colours of the solution at different pH values were measured as for Example 1. ΔEab* was calculated between pH 7 and pH 5 and between pH 7 and pH 3.

Red cabbage + tannic acid

| | L* | a* | b* | h_{ab} | ΔEab* |
|---|---|---|---|---|---|
| pH 7 | 47.1 | 5.5 | 7.5 | 54 | — |
| pH 5 | 51.2 | 8.6 | 7.1 | 40 | 5.2 |
| pH 3 | 48.5 | 18.6 | 7.8 | 23 | 13.2 |

This red cabbage colour with tannic acid was not blue at any of the pH values, it was a reddish brown colour.

Red Cabbage+Fe(II)

In a 1 L Duran flask, equipped with a magnetic stirrer the red cabbage extract (32.2 g) was diluted with demineralised water (700 mL). Disodium hydrogen phosphate (5.7 g) and sodium bicarbonate (2.15 g) were slowly added to have a 5.5<pH<6.0. Then ferrous sulphate heptahydrate (4.18 g) was added. The solution was pasteurized at 75° C. for 2 h and cooled down to room temperature. The colours of the solution at different pH values were measured as for Example 1. ΔEab* was calculated between pH 7 and pH 5 and between pH 7 and pH 3.

Red cabbage + Fe(II)

| | L* | a* | b* | h_{ab} | ΔEab* |
|---|---|---|---|---|---|
| pH 7 | 34.9 | −5.3 | −5.5 | 226 | — |
| pH 5 | 44.5 | 14.8 | −3.5 | 347 | 22.3 |
| pH 3 | 41.1 | 23.7 | −1.7 | 356 | 29.9 |

The red cabbage with Fe(II) was blue at pH 7, but as the acidity was increased to pH 5 and pH 3, the colour changed, becoming red.

Red Cabbage+Fe(II)+Tannic Acid

A blue colouring composition with red cabbage extract, Fe(II) and tannic acid was prepared in the same way as for Example 8. The colours at different pH values were measured as for Example 1. ΔEab* was calculated between pH 7 and pH 5 and between pH 7 and pH 3.

Red cabbage + Fe(II) + tannic acid

| | L* | a* | b* | h_{ab} | ΔEab* |
|---|---|---|---|---|---|
| pH 7 | 38.4 | −2.1 | −6.3 | 252 | — |
| pH 5 | 39.6 | −1.8 | −6.4 | 255 | 1.2 |
| pH 3 | 43.5 | 1.95 | −6.8 | 286 | 6.9 |

This demonstrates that the cabbage extract with Fe(II) stabilized by tannic acid remains blue down to pH 3. This is in contrast to the cabbage extract with only Fe(II) which does not provide a stable blue colour. Using tannic acid alone with cabbage extract does not give a blue colour at pH 7 or below.

1. A coloring composition having a blue color wherein the composition comprises: at least one anthocyanin; metal ions selected from the group consisting of Al(III), Ca(II), Cu(II), Fe(II), Fe(III), Mg(II), Mn(II), Zn(II) and combinations thereof; and at least one stabilizer selected from the group consisting of tannic acid and phospholipids.

2. A coloring composition according to claim 1 wherein the pH of the coloring composition is less than 7.

3. A coloring composition in accordance with claim 1, wherein the anthocyanin is from a natural source.

4. A coloring composition in accordance with claim 1, wherein the anthocyanin is added in the form of: a plant material; or an extract of plant material.

5. A coloring composition in accordance with claim 4, wherein the plant material is selected from the group consisting of red cabbage, red onion, purple sweet potato, grape, cranberry, strawberry, raspberry, chokeberry, black soybean, blackcurrant, elderberry, hibiscus, radish, blueberry, bilberry, cherry, aubergine, black carrot, purple carrot, and black rice.

6. A coloring composition in accordance with claim 1, wherein the coloring composition comprises one or more acidity regulators.

7. A coloring composition in accordance with claim 1, wherein the ΔEab* between pH 7 and pH 5 is less than 10.

8. A coloring composition in accordance with claim 1, wherein the molar ratio of the metal ions to the anthocyanins is at least 0.5:1.

9. A coloring composition in accordance with claim 1, wherein the molar ratio of the stabilizer to the anthocyanins is at least 0.5:1.

10. A coloring composition in accordance with claim 1, wherein the coloring composition is a spray-dried powder further comprising a spray drying carrier.

11. A method for coloring a food, a nutritional formulation, a food supplement, a beverage, an ink or a pharmaceutical product comprising: the step of adding a coloring composition having a blue color wherein the composition comprises at least one anthocyanin; metal ions selected from the group consisting of Al(III), Ca(II), Cu(II), Fe(II), Fe(III), Mg(II), Mn(II), Zn(II) and combinations thereof; and at least one stabilizer selected from the group consisting of tannic acid and phospholipids to the product.

12. Method according to claim 11, wherein the food product is selected from the group consisting of a confectionery product, a bakery product, an ice-cream or and a pet food.

13. Method according to claim 11, wherein the coloring composition is combined with another coloring composition.

14. A method of preparing a blue coloring composition comprising adjusting the pH of an anthocyanin solution to between 3.5 and 8.0 before adding metal ions selected from the group consisting of Al(III), Ca(II), Cu(II), Fe(II), Fe(III), Mg(II), Mn(II), Zn(II) and combinations thereof; and at least one stabilizer selected from the group consisting of tannic acid and phospholipids.

15. Composition comprising the coloring composition A coloring composition having a blue color wherein the composition comprises at least one anthocyanin; metal ions selected from the group consisting of Al(III), Ca(II), Cu(II), Fe(II), Fe(III), Mg(II), Mn(II), Zn(II) and combinations thereof; and at least one stabilizer selected from the group consisting of tannic acid and phospholipids, wherein the composition has a pH in the range of 3.5 to 8.0 and the composition has a blue or green color.
